(19) United States
(12) Patent Application Publication
(10) Pub. No.: US 2010/0274693 A1
(43) Pub. Date: Oct. 28, 2010

(54) METHOD FOR PERFORMING A PARKING PROCEDURE WITH THE HELP OF A MOBILE COMMUNICATION DEVICE

(75) Inventors: Thomas Bause, Hannover (DE); Andreas Kompart, Sankt Augustin (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: DEUTSCHE TELEKOM AG, Bonn (DE)

(21) Appl. No.: 12/738,489

(22) PCT Filed: Oct. 14, 2008
(86) PCT No.: PCT/EP08/08681

§ 371 Date: Jul. 8, 2010

(30) Foreign Application Priority Data
Oct. 17, 2007 (DE) 10-2007-050-055.8

(51) Int. Cl. G06Q 30/00; G08G 1/14; H04W 4/04; G06Q 40/00

(52) U.S. Cl. 705/32; 340/932.2; 455/466

(57) ABSTRACT

A method for processing a parking transaction using a mobile communication device connected to a public mobile communication network includes: determining location-based data that establish a location where the mobile communication device is currently located; transmitting to a central management and monitoring device the location-based data and an individual identifier that is stored in the mobile communication device; converting the location-based data to a predefined parking zone; and checking, in response to the individual identifier, whether a user of the mobile communication device is entitled to park a vehicle in the parking zone.

### CROSS-REFERENCE TO PRIOR APPLICATIONS

This applications is a U.S. National Phase application under 35 U.S.C. §371 of International Application No. PCT/EP2008/008681, filed on Oct. 14, 2008 and claims benefit to German Patent Application No. DE 10 2007 050 055.8, filed on Oct. 17, 2007. The International Application was published in German on Apr. 23, 2009 as WO 2009/049859 A2 under PCT Article 21(2).

### FIELD

The invention relates to a method for processing a parking transaction using a mobile communication device connected to a public mobile communication network.

### BACKGROUND

In order to make fee-based parking easier for automobile drivers, studies are currently underway of cell phone parking systems in which cell phones are used for billing of parking fees accurate to the minute.

For example, a cell phone parking method is being tested as part of the EU project TELLUS. Here, an automobile driver must dial the operator of the cell phone parking system at the beginning of the parking transaction using his cell phone. The operator thereupon communicates to the automobile driver what district of the city he is located in and what the applicable rate for parking is. To end the parking transaction, the automobile driver must call the operator in an additional call at a second telephone number.

### SUMMARY

In an embodiment, the present invention provides a method for processing a parking transaction using a mobile communication device connected to a public mobile communication network. The method includes a) determining location-based data that establish a location where the mobile communication device is currently located; b) transmitting to a central management and monitoring device the location-based data and an individual identifier that is stored in the mobile communication device; c) converting the location-based data to a predefined parking zone; d) checking, in response to the individual identifier, whether a user of the mobile communication device is entitled to park a vehicle in the parking zone.

### BRIEF DESCRIPTION OF THE DRAWINGS

The invention is further described in more detail with reference to an exemplary embodiment depicted in the following drawings, in which:

FIG. 1 is a communication system based on a mobile communication network which supports the cell phone parking according to the invention.

FIG. 2 is a flowchart to show check-in of a vehicle at the start of a parking transaction.

FIG. 3 is a flowchart to show a status query of the parking status, and

FIG. 4 is a flowchart to show check-out of a vehicle at the end of a parking transaction.

### DETAILED DESCRIPTION

In one embodiment, a method is provided for processing a parking transaction using a mobile communication device which makes utilization of the so-called cell phone parking service easier, more convenient, and more secure for a customer.

According to this embodiment, the location of a driver who is in possession of a mobile communication device is detected in order to be able to check whether the driver is located in a parking zone in which he is permitted to park. The determination as to whether the driver is located in a permissible parking zone is made based on GSM coordinates or a mobile communication network cell identifier, which defines the current location of the driver. It is known to subdivide the coverage area of a mobile communication network into network cells and to assign to each network cell an identifier or identification (ID) that defines the geographic position of the network cell in question.

The technical problem is solved by a method for processing a parking transaction using a mobile communication device connected to a public mobile communication network.

According to the disclosed method, location-based data are determined that establish the location where the mobile communication device of a user is currently located and where the vehicle of the user is to be parked. The location-based data and an individual identifier that is stored in the mobile communication device are transmitted to a central management and monitoring device, hereinafter also referred to as a data processing center. The individual identifier is preferably the telephone number of the mobile communication device. In the central management and monitoring device, the location-based data are converted to a predefined parking zone. In response to the individual identifier, a check is made to determine whether the user of the mobile communication device is entitled to park a vehicle in the parking zone that has been determined This check advantageously includes the steps for determining whether the user is entitled in the first place to use the method, which is to say the mobile parking service, and if so, whether he is located in the area covered by the mobile parking service.

If at least one parking space is allocated to the parking zone, then according to the embodiment, a check is now made to determine whether an unoccupied parking space is available, as long as the user is entitled to use the parking zone. Here, a parking zone need not be subdivided into multiple parking spaces, but can also contain only a single parking space.

In addition, digital road maps that have streets or street sections containing predefined parking zones are stored in the central management and monitoring device. Parking zone identifiers are associated with the defined parking zones, which facilitate the management and monitoring of parking vehicles. Furthermore, GSM coordinates and mobile communication network cell identifiers are associated with the streets or street sections which contain the parking zones. In order to be able to use the localized position of the mobile communication device, and hence of the vehicle to be parked, to determine the parking zone associated with the location, the determined location-based data are represented by GSM coordinates or a mobile communication network cell identifier. The GSM coordinates or mobile communication network cell identifier are determined from the mobile communication device or from the mobile communication network, for example from a receiving device of the telecommunications carrier.

In order to permit an easy, convenient, and secure parking transaction for the user, the vehicle license plate number of the user's vehicle, the individual identifier, the location-based data, and if applicable a notation of a parking request of the user are transmitted in an SMS message to the central management and monitoring device via an SMS gateway associated with the mobile communication network.

In order for the user to initiate the parking transaction by just a single press of a button on his mobile communication device, the vehicle license plate number of the user's vehicle, the individual identifier, and the telephone number of the SMS gateway are stored in the mobile communication device, in particular on a SIM card of the mobile communication device. When a predefined button is pressed, the SMS message with the vehicle license plate number of the user's vehicle, the individual identifier, and if applicable a notation of a parking request of the user, is generated and transmitted to the SMS gateway.

If the location-based data are determined by the mobile communication device itself, then these data are also transmitted in the SMS message from the mobile communication device to the SMS gateway. In contrast, if the location-based data are determined by the mobile communication network, then these data are embedded in the SMS message at a suitable point in the mobile communication network and then forwarded to the SMS gateway.

In response to receiving the SMS message, the central management and monitoring device generates a time stamp that indicates the parking start time. In addition, the central management and monitoring device can determine, using a stored data record, whether an unoccupied parking space is available in the parking zone. If so, the vehicle license plate number, the parking start time, and the parking zone are stored in a database. Instead of the parking zone, a parking zone identifier associated with the parking zone may also be stored.

With the above-described method, a driver is able to check-in his vehicle to a parking inventory by pressing just a single button. Verification as to whether the driver is permitted to use the mobile parking service, is located in an authorized parking zone, and whether unoccupied parking spaces are available in the authorized parking zone takes place without his participation.

In order to be able to end the parking transaction, an indication of the parking end time and the individual identifier are transmitted from the mobile communication device to the central management and monitoring device. This information is advantageously embedded in an SMS message and transmitted when a single button of the mobile communication device is pressed. In the central management and monitoring device, a time stamp is generated that indicates the parking end time. In response to the parking start time and parking end time, the parking duration can be calculated.

This method ensures that a parked vehicle can be checked out of a parking inventory by the press of just a single button, as well.

Thanks to the method described, the participation of the driver in check-in and check-out of a vehicle to be parked is reduced to a minimum, thus significantly reducing erroneous check-ins or check-outs resulting from incorrect entries. In particular, the driver need not have any familiarity with a place in order to be able to identify the parking zone.

In response to the parking duration and the parking zone, the central management and monitoring device can determine the parking fee to be paid.

If the user of the mobile communication device has a prepaid account, then the central management and monitoring device can inform the user of the maximum parking duration—as a function of the account balance, the parking start time, and the parking fee for the parking zone in question—via a message on the mobile communication device.

In addition, the prepaid account can automatically be debited by the amount of the parking fee.

In order to be able to check the vehicle out from the parking inventory after completion of the parking transaction, the vehicle license plate number can be deleted from the database again.

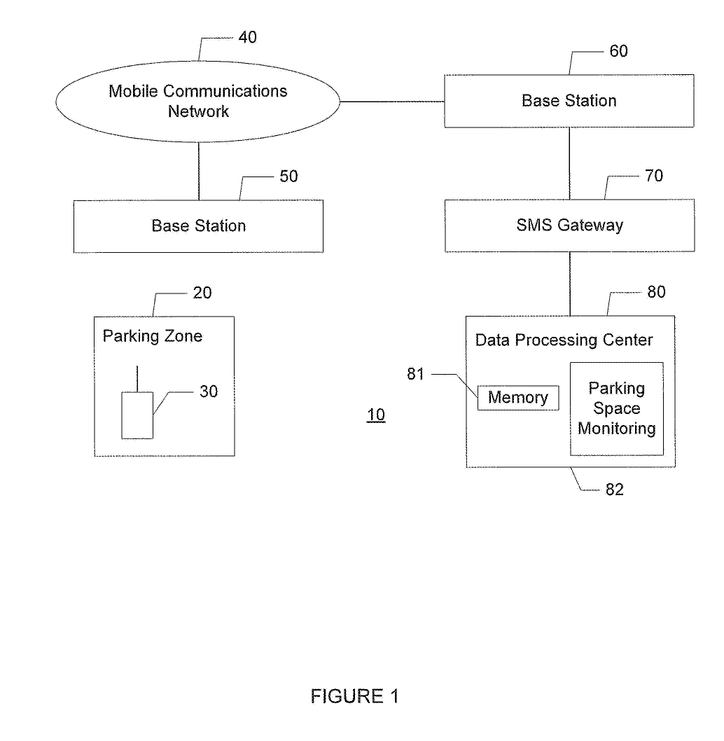

Now turning to the drawings, FIG. 1 schematically shows a communication system 10, which has a public mobile communication network 40. Merely for the purpose of simplified representation, only two base stations 50 and 60 are connected to the mobile communication network 40. Likewise for the purpose of simplified representation, only one parking zone 20 is shown, in which a driver may park his car. Let it be assumed that the parking zone 20 is subdivided into multiple parking spaces. The vehicle to be parked is symbolically represented by a mobile communication device, for example a cell phone 30. The base stations 50 and 60 are connected to an SMS gateway 70 of a cell phone parking service provider, which is configured to receive from the cell phone 30 or to the cell phone 30. The SMS gateway 70 can be reached at a dedicated SMS services telephone number of a cell phone parking service provider. The telephone number of the SMS gateway and the vehicle license plate number of the vehicle of the cell phone user are stored on a SIM card in the cell phone 30, and do not have to be entered separately. However, the stored vehicle license plate number can also be changed, as will be explained below.

The SMS gateway 70 is connected to a data processing center 80, hereinafter also referred to as a central management and monitoring device. The data processing center has at least one storage device 81, in which may be stored, for example, relevant data on checked-in vehicles, parking zone rates, and the like.

Below, the manner in which the cell phone parking service functions is explained in more detail. Before a driver can use the cell phone parking service, he registers with a cell phone parking service, for example over the Internet. During registration, the user enters the telephone number of his cell phone 30, the license plate number of his vehicle that he typically drives, and if applicable, information for payment of the parking fee (prepaid account, checking account, credit card number, and the like) at a personal computer or his cell phone 30. After the user has registered successfully, the cell phone telephone number and the vehicle license plate number are stored, for example in the memory 81, for later verification purposes.

Depending on the payment method, the user can maintain his cell phone parking account in either anonymous or personalized form. In the present example, it is assumed that the cell phone parking service permits nationwide use.

After successful registration, the user receives an applet for using the cell phone parking service, which is transmitted to his cell phone 30 by his mobile communication service provider, for example (over-the-air transmission). The applet automatically installs itself on the SIM card of the cell phone 30. The applet already contains the vehicle license plate number that the user entered during registration, as well as the telephone number of the SMS service gateway 70 that is used for posting parking transactions. Accordingly, the vehicle license plate number and the telephone number of the SMS gateway 70 are also stored on the SIM card of the cell phone 30 at installation of the applet.

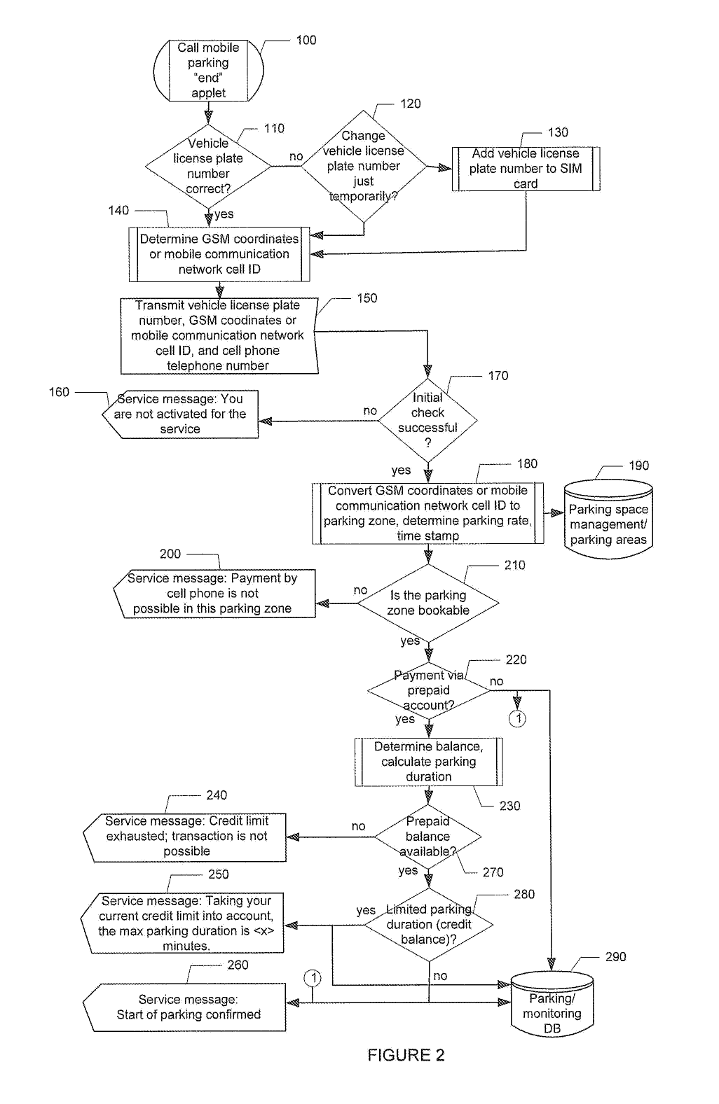

Now let us assume that the user of the cell phone 30 would like to park his motor vehicle in the parking zone 20. The precise sequence of checking in a vehicle is now explained with reference to FIG. 2.

The user first calls the applet stored on the SIM card of the cell phone 30 in order to initiate the parking transaction, as is shown in block 100. After the call, the vehicle license plate number stored on the SIM card is displayed on the cell phone 30. The user can now confirm in the decision block 110 that the vehicle license plate number stored on the SIM card is associated with the vehicle he is driving at the moment. If the license plate number is correct, block 140 is executed. If the vehicle license plate number is not correct, the user now has the option in block 120 of temporarily changing the vehicle license plate number simply by the press of a button. In this case, the new license plate number is temporarily stored on the cell phone 30. Alternatively, the user can also permanently change the vehicle license plate number stored on the SIM card in block 130.

Once the correct vehicle license plate number is displayed on the cell phone 30, according to a preferred embodiment the cell phone 30 determines, in block 140, the GSM coordinates or the mobile communication network cell identifier of the mobile communication network 40, which defines the current location of the mobile communication device 30. In block 150, by a simple press of the button, the user causes the cell phone to generate an SMS message, which contains the vehicle license plate number, an indication of a parking start time, the telephone number of the cell phone 30, the GSM coordinates or the mobile communication network cell identifier, and to automatically transmit the message to the data processing center 80 via the mobile communication network 40 and the SMS gateway 70 using the SMS service number stored on the SIM card. If the GSM coordinates or the mobile communication network cell identifier are not determined by the cell phone 30, then these data are provided by the mobile communication network 40 itself, and added to the SMS message at an appropriate point.

In block 170, the data processing center 80 performs an initial check in response to the received SMS message. The initial check determines, for example, whether the user of the cell phone 30 is even activated for the cell phone parking service. To this end, the system checks whether the cell phone telephone number received in the SMS message and possibly the vehicle license plate number are contained in the memory 81. If the corresponding cell phone telephone number is not present in the memory 81, which is to say the user has not been activated, then in block 1860 a corresponding SMS message is transmitted from the data processing center to the cell phone 30 via the SMS gateway 70 and the mobile communication network 40. However, if the data processing center 40 recognizes that the user of the cell phone 30 has been registered for cell phone parking, then a time stamp that indicates the parking start time is generated in block 180. In addition, the parking zone 20 in which the user of the cell phone 30 would like to park his vehicle is determined from the GSM coordinates or the mobile communication network cell identifier received in the SMS message.

In order to be able to convert the received GSM coordinates or mobile communication network cell identifier into the parking zone 20, according to an exemplary embodiment an electronic road map is stored in a database 190. In the present example, the electronic map contains all streets or street sections, predefined fee-based parking zones within Germany, and the parking rate of each parking zone. In addition, a lookup table can be stored in the database 190 in which corresponding GSM coordinates or the corresponding mobile communication network cell identifier are associated with each defined parking zone. Moreover, a unique parking zone identifier can also be associated with each parking zone. In response to the GSM coordinates or mobile communication network cell identifier received in the SMS message, the data processing center 80 can find the associated parking zone stored in the database 190.

In block 210, the data processing center 80 further checks whether the parking zone 20 is bookable. This check is carried out using the data stored in the database 190, for example. If a parking zone is subdivided into multiple parking spaces, the database 190 also contains information on how many parking spaces are occupied or are still unoccupied. If the GSM coordinates or corresponding mobile communication network cell identifier received in the SMS message identify a stored parking zone, the data processing center checks—using the cell phone telephone number and/or vehicle license plate number contained in the SMS message, for example—whether the user is permitted to book the parking zone 20. If yes, the center further checks whether the parking zone is at all bookable at the moment, which is to say the parking spaces are not off-limits for special purposes, for example the weekly market. If the parking zone is not bookable, according to decision block 210 the data processing center 80 generates an SMS message, which is transmitted to the cell phone 30. The SMS message informs the user of the cell phone 30 that the parking zone 20 where he is currently sitting is not bookable, at least not at present.

If the parking zone 20 is bookable, the user of the cell phone 30 is checked into the data processing center using the vehicle license plate number, the time stamp that signals the start of parking, and the parking zone 20 or its parking zone identifier. These data may be stored in the database 190 or in a separate memory.

If the determination is made in decision block 210 that the parking zone 20 is bookable by the user, a check is made in decision block 220 to determine whether the user specified at registration that payment is to be made through a prepaid account. If no prepaid account was agreed upon, the parking space monitoring device 82 executes a different billing process. The data required for this process can be stored in a database 290.

For the case that the decision block 200 determines that the user has a prepaid account, in block 230 the data processing center 80 determines the available balance. The maximum parking duration may also be calculated in block 230 as a function of the balance determined, the parking zone 20, and the parking rate for the parking zone 20 stored in the data processing center 80. Moreover, a check can be made in decision block 270 as to whether a balance is still present in the user's prepaid account. If not, an SMS message is transmitted from the data processing center 90 to the cell phone 30, in which the user is informed in block 240 that his credit limit has been reached, and hence the parking fees cannot be paid. However, if a balance is still present in the prepaid account, the decision block 270 branches to a decision block 280.

In the decision block 280, a check can be made as to whether the balance allows for a parking duration that is above or below a threshold value. If the balance is below a threshold value, the user of the cell phone 30 is notified by means of an SMS message generated in the data processing center 80 that the available balance permits only a limited parking duration. The maximum available parking duration is then displayed in the cell phone 30, as indicated by block 250, and if applicable, is stored in the database 290 together with the cell phone telephone number and/or the vehicle license plate number. However, if a sufficient balance is present in the prepaid account, this information can also be stored in the database 290. In addition, an SMS message is generated by the data processing center 80 and transmitted to the cell phone 30 which confirms the start of parking to the cell phone user as shown in block 260.

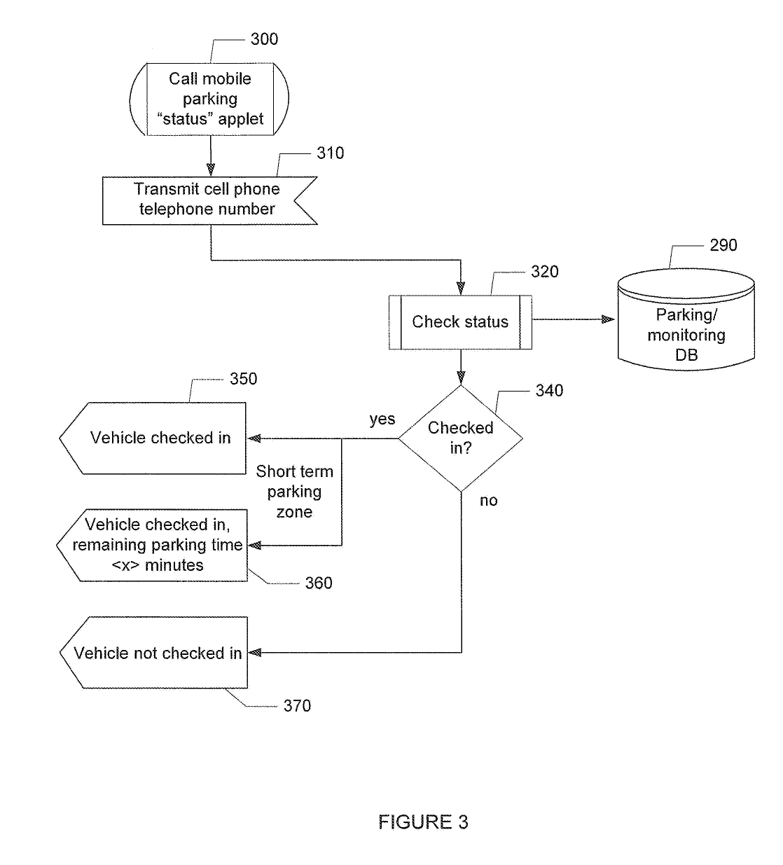

Now the sequence of a parking status query is explained with reference to FIG. 3.

Once again, the user can call the “cell phone parking” applet on his cell phone 30 in order to query the parking status, as shown in block 300. In step 310, the cell phone 30 transmits an SMS message which contains the vehicle license plate number stored on the SIM card, the stored cell phone telephone number, and a note to determine the parking status. The SMS message is transmitted to the data processing center 80 via the SMS gateway 70. In response to the SMS message received, the parking space monitoring device 82 executes a status check in block 320. To this end, the parking space monitoring device 82 queries the database 290. During the status check, a check is made in decision block 340 to determine whether the vehicle with the vehicle license plate number contained in the SMS message is checked in, is checked in with a limited parking duration, or is not checked in. The corresponding parking status is transmitted in an SMS message from the data processing center to the cell phone 30, as is shown by the blocks 350, 360, and 370.

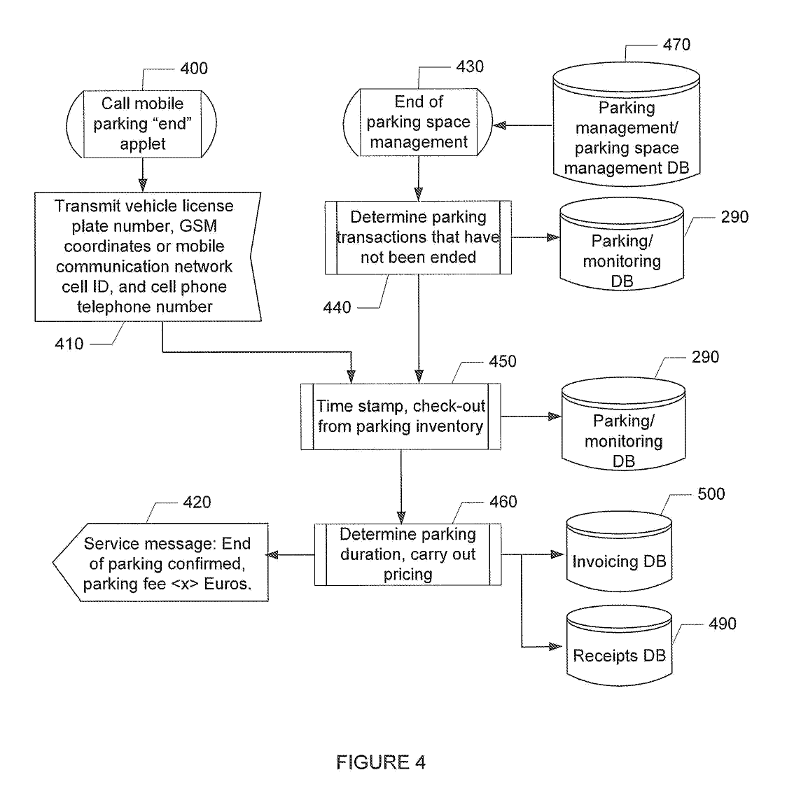

Now we will consider FIG. 4 in order to explain the sequence when ending a parking transaction.

When the parking zone user is ending the parking transaction, he again calls the “cell phone parking” applet on his cell phone 30, as shown in block 400. At the press of a single button, the cell phone 30 generates an SMS message which can contain an indication of the end of parking, the cell phone telephone number, the vehicle license plate number and/or the GSM coordinates or the mobile communication network cell identifier. The SMS message is then transmitted to the data processing center 80 via the SMS gateway 70, using the SMS service telephone number stored in the SIM card. This process is shown in block 410. In response to receiving the SMS message, the data processing center 80 generates a time stamp which signals the end of parking, as shown in block 450. The time stamp can be stored together with the vehicle license plate number, the cell phone telephone number and/or the GSM coordinates or the mobile communication network cell identifier in the database 290 or the database 190. At the same time, or at a later point in time, check-out of the vehicle from the parking inventory is carried out in that the vehicle license plate number is deleted from the database 290 or 190, for example. Even though the vehicle has been checked out of the database 190 or 290, it advantageously still remains temporarily visible for the parking space monitoring device 82.

In response to the parking start time stored in the data processing center 80 and the parking end time determined, the parking duration for the cell phone number is determined, as shown in block 460. In addition, the parking fee to be paid can be calculated from the parking rate associated with the parking zone 20, which likewise is stored in the data processing center. If the user specified a prepaid account at registration, debiting of the parking fees can take place immediately in block 460. The parking end time and the amount of the parking fee are transmitted in an SMS message from the data processing center 80 to the cell phone 30 via the SMS gateway 70. The corresponding service message is shown symbolically in block 420.

In block 460, appropriate invoicing and parking receipt data can be prepared, which are stored in a database 500 or 490. The user can obtain the parking receipt through a special account on the Internet, for example, and print it out himself

According to a further embodiment, daily parking space management starts and ends at certain times, which are stored in a database 470. The data processing center 80 determines the daily end of parking space management from the data stored in the database 470.

In collaboration with the parking space provider, it can be resolved in each case whether parking zone users who are still checked in at the end of the parking space monitoring time should be checked out automatically. Using the vehicle license plate numbers and/or cell phone numbers stored in the database 190 or 290, the data processing center can determine the vehicles that still had not been checked out after the end of parking space management. Moreover, it is possible to determine which parking zones are unoccupied or occupied from the GSM coordinates or mobile communication network cell identifiers that are additionally stored. This is shown in block 440. The vehicle license plate numbers of the vehicles that have not been checked out and the end time of parking space management are stored in the database 290, for example.

If the parking space users that are still checked in are to be automatically checked out when the parking space management time ends, processing of the parking transaction is continued in block 450. If, in contrast, the parking space users who are still checked in are to be automatically checked in again the next day when parking space management starts again, then in block 440 the time stamp that indicates the end of daily parking space management and the vehicle license plate number of the vehicle of the parking space user that has not checked out are stored in the database 290. At the start of the next parking space management period, the data processing center 80 can resume in function block 180 and decision block 210 with regard to the parking space users who are still checked in. It must additionally be noted that the employees of a municipal parking space monitoring facility can access the database 190 and/or 290 in order to check whether a vehicle is checked in.

While the invention has been described with reference to particular embodiments thereof, it will be understood by those having ordinary skill in the art that various changes may be made therein without departing from the scope and spirit of the invention. Further, the present invention is not limited to the embodiments described herein; reference should be made to the appended claims.

1.-11. (canceled)

12. A method for processing a parking transaction using a mobile communication device connected to a public mobile communication network, comprising:
a) determining location-based data that establish a location where the mobile communication device is currently located;
b) transmitting to a central management and monitoring device the location-based data and an individual identifier that is stored in the mobile communication device;
c) converting the location-based data to a predefined parking zone; and
d) checking, in response to the individual identifier, whether a user of the mobile communication device is entitled to park a vehicle in the parking zone.

13. The method according to claim 12, wherein the location-based data represent at least one of GSM coordinates and a mobile communication network cell identifier, which are determined from at least one of the mobile communication device and the mobile communication network, and wherein the individual identifier is a telephone number of the mobile communication device.

14. The method according to claim 12, wherein in b), a vehicle license plate number of a user vehicle, the individual identifier, and the location-based data are transmitted in an SMS message to the central management and monitoring device via an SMS gateway associated with the mobile communication network.

15. The method according to claim 14, wherein the SMS message further includes a notation of a parking request of the user.

16. The method according to claim 14, wherein the vehicle license plate number and the telephone number of the SMS gateway are stored in the mobile communication device, and wherein the SMS message is generated and transmitted by a single press of a button on the mobile communication device.

17. The method according to claim 14, wherein the central management and monitoring device, in response to receiving the SMS message, generates a time stamp indicative of a parking start time, and wherein the vehicle license plate number, the parking start time, and the parking zone are stored in a database.

18. Method according to claim 17, further comprising:
transmitting, by the mobile communication device, an indication of a parking end time and the individual identifier to the central management and monitoring device;
generating, in the central management and monitoring device, a time stamp indicative of the parking end time; and
calculating, in response to the parking start time and parking end time, a parking duration.

19. The method according to claim 18, further comprising calculating, in response to the parking duration and the parking zone, a parking fee to be paid.

20. The method according to claim 16, further comprising transmitting a message about a maximum parking duration to the mobile communication device as a function of the account balance of a prepaid account of the user, the parking start time, and the parking zone.

21. The method according to claim 20, further comprising automatically debiting the prepaid user account the amount of the parking fee.

22. The method according to claim 18, further comprising deleting the associated vehicle license plate number from the database so as to check the parked vehicle out.

23. The method according to claim 12, wherein when the user of the mobile communication device is entitled to park a vehicle in the parking zone, a check is carried out as to whether an unoccupied parking space is available in the parking zone.
